(19) United States
(12) Patent Application Publication
(10) Pub. No.: US 2010/0327604 A1
(43) Pub. Date: Dec. 30, 2010

(54) Human powered pull strings generator

(76) Inventors: Shawn Zhu, Stormville, NY (US); Anna Zhu, Stormville, NY (US)

Correspondence Address: Shawn Zhu, 132 Devon Farms Road, Stormville, NY, 12582, US

(21) Appl. No.: 12/459,228

(22) Filed: Jun. 27, 2009

(51) Int. Cl. F03G 5/06

(52) U.S. Cl. 290/1 R

(57) ABSTRACT

A double strings rotor system comprising of at least one set of double strings anchored at a rotor with a shaft (optional) is disclosed. An improved human powered pull strings generator comprises the double strings rotor system, a stator system, an electrical circuit system, and a cover protection system (optionally without the cover protection system). The rotation of the rotor is provided by repeatedly pulling and un-pulling the twisted double strings with one or two hands and electricity can be generated using this improved human powered pull strings generator, which can power an electrical device.

### BACKGROUND OF THE INVENTION

A magnet has south and north poles with invisible magnetic lines. If a conducting wire moves relative to the magnet (or vice versa) in such a way that the wire cuts through the invisible magnetic line, an electric current is generated along the wire. This is called Faraday's law of electromagnetic induction. The electricity power output is proportional to the relative moving speed, total length of wiring that cuts through the magnetic lines, and magnetic field strength. This magnetic induction phenomenon has led to many inventions of electricity generation devices. One of the examples is pull string generators (US patent application 20080150378, Chinese patent application 200720086028), which use the same principle as a yo-yo. The key to this device is that it has a string wound around the shaft of a rotor whose circular movement is provided by winding and unwinding while pulling the string back and forth.

When the current generated by a generator is an alternating current (AC), the generator is called an alternator. AC current has limited use. It can be used to light a light bulb, or a light emitting diode (LED). It is well known to the ordinarily skilled in the art that an AC current can be easily converted to a direct current (DC) by various means, such as a bridge rectifier. If the bridge rectifier is coupled with a capacitor, a relatively smooth DC current can be produced. A DC current can be used to charge a battery and power an electrical device such as a radio, a computer, a cell phone, and of course, a light bulb.

Methods for constructing rotor and stator configurations for human power generation are well known to the ordinarily skilled in the art. In the specification herein, a rotor is defined as a device capable of rotation when a net rotational mechanical force is applied to its rotation axis. A stator is defined as a stationary device always used along with the rotor for electricity generation when the rotor is rotating. A rotor and a stator (plus an electrical load) constitute a Faraday's electromagnetic induction circuit. The rotor can be either the magnetic part or the conducting coil part of the Faraday's circuit. In the case that the rotor contains magnets, the stator contains conducting coils. In this case, the rotor can be a magnet or groups of magnets. In the case that the rotor contains the coils, the stator contains the magnets.

In the specification herein, a rotor-stator pairing configuration is defined as peripheral if the axis connecting the N/S poles of the magnets is perpendicular to the rotation axis, or axial flux if the axis connecting the N/S poles of the magnets is parallel to the rotation axis.

A few non-limiting examples of rotor-stator pairing configurations are: (1) A magnet (the rotor) sits inside the stator (a peripheral configuration); (2) The stator which has many evenly spaced coils along the rim of a disk (or wheel) is surrounded by the rotor which has many evenly spaced magnets arranged in a shape of circle (a peripheral configuration) as demonstrated in US patent application 20080150378; (3) The rotor which has many evenly spaced-magnets along the rim of a disk is surrounded by the stator which has many evenly spaced coils arranged in a shape of circle (a peripheral configuration); (4) The rotor with magnets is parallel (face-to-face) to the stator with coils (an axial flux configuration). As it was pointed out earlier the rotor can contain the coils while the stator contains the magnets; in this case, a brush or a commutator design is usually necessary to be included with the rotor.

It is well known to the ordinarily skilled in the art that, when constructing the rotor-stator pair for power generation, the coils should be placed in such a way that, when the rotor rotates, the wires in the coils cut through the magnetic lines preferably at a right angle and should be connected in such a way that the induced electricity currents from various coils or different parts of the same coils should not cancel each other. It is also well known to the ordinarily skilled in the art that the output power can be enhanced if the coils are wound around a magnetite. The magnetite is called a coil core (or in the case that the stator has the coils, it is called a stator core). Throughout the specification, when a coil is mentioned, it shall be understood that it means the coil may or may not have magnetite in it.

The pull string rotor design of the existing technology (US patent application 20080150378, Chinese patent application 200720086028) generates its mechanical energy input through a string wound around a shaft when the string is pulled. Each rotation of the rotor corresponds to each turn of the string on the shaft. Because of this design, it requires a large travel distance (for example, 0.5-2 meters or a full arm's length) to operate while pulling the string. This large operation length sometimes creates a problem when the operator of such pull string device is in a confined space or a space that restricts excessive noise or distraction.

### SUMMARY OF THE INVENTION

We now disclose an improved human powered pull strings generator which comprises a double strings rotor system, a stator system, an electrical circuit system, a cover protection system (optionally without the cover protection system), and a method of using the improved pull strings power generator.

The double strings rotor system comprises a rotor, a pulling double strings system, and a shaft (optionally without the shaft). When the shaft is absent or the shaft is not supported by a rotor support system, the pulling double strings system comprises at least two sets of double strings anchored at both sides of the rotor body or the shaft. The rotation of the rotor is provided by repeatedly pulling and un-pulling the two sets of double strings. The pulling action untwists the double strings while the un-pulling action twists the double strings.

In the case that the shaft is supported and fixed with one or two bearings on the stator frame, the rotor system can also have only one set of double strings anchored to only one side of the rotor or to the shaft. The rotation of the rotor is provided by repeatedly pulling and un-pulling the one set of double strings.

The stator system comprises at least one stator, a rotor supporting system (optionally without the rotor supporting system), optionally a handle, and optionally a string guiding system (such as a pulley system).

The pairing configurations of the rotor and stator, as mentioned previously, includes peripheral and axial flux and they are not within the scope of the present invention since they are well-known to the skilled in the art. However, a generator which uses these configurations together with the design of the double strings rotor system and stator system of the present invention is within the scope of the present invention. For the purpose of clarity, other well-known rotor-stator pairing configurations will not be discussed in detail so that the invention is not unnecessarily obscured.

In the case that the rotor contains magnets, the stator is contains conducting coils. In the case that the rotor is the one with the coils, the stator is the one with magnets.

The electrical circuit system comprises at least one of the following electrical components: a light bulb circuit, a bridge rectifier circuit, capacitors, a feedback circuit, a voltage and current conditioning circuit, an on/off switch circuit, an electricity storage circuit, or any combination of these circuits. The design of the electrical circuit is not in the scope of the present invention and they will not be discussed in detail. However, a human powered generator using the electrical circuits together with the improved pull strings design of the present invention and method of using such a device is within the scope of the present invention.

One embodiment is a generator of the present invention whose electrical circuit is capable of charging an electricity storage device such a battery or an ultracapacitor and providing appropriate power output to power an electrical device. Another embodiment is a generator of the present invention whose electrical circuit is capable of providing auxiliary power to the rotor (when the rotor is slowing down that may result in a unsustainable rotation). Yet another embodiment is a generator of the present invention whose electrical circuit is capable of burning off the excess power when the electricity storage device is full. Still yet another embodiment is a generator of the present invention whose electrical circuit is capable of turning the electrical circuit automatically on and off when directed.

The pull strings power generation method of the present invention comprises the following steps: (1) From its initial still state, rotate the rotor slowly so as to twist the double strings anchored to the rotor; (2) pull the strings so that it creates a mechanical force along the axis of the rotation. The pulling force un-twists the double strings making the rotor rotate in an opposite direction; (3) as soon as the double strings are un-twisted to the un-twisted state (the longest string state), un-pull the strings; (4) when the strings are twisted again, pull the strings again; (5) repeat steps (2) to (4) to maintain the rotation of the rotor. When paired up with a stator, the rotation of the rotor induces a current along the conducting wires, which can be used to power an electrical circuit system.

The improved pull strings generator is human powered and it can be useful as an on-demand electricity generator. It can be used to charge an electricity storage device and provide electricity to radios, cell phones, computers, and other electrical devices in remote areas where regular electricity is not accessible. It is obvious that the present invention employs a twisting mechanism which is different from the winding mechanism in the existing technology. Unlike the pulling string generator of the existing technology, the operation of the twisting mechanism of the present invention requires a much shorter pulling distance and produces less distraction.

It is an object of the present invention to provide a double strings rotor system.

It is another object of the present invention to provide an improved pull strings generator in which the generator provides an AC current.

It is yet another object of the present invention to provide an improved pull strings generator in which the generator provides a DC current.

It is yet another object of the present invention to provide a pull strings generator in which the generator can supply power to an electrical device such as an electricity storage device.

It is yet another object of the present invention to provide a method for generating the electricity by pulling and un-pulling the double strings anchored to the rotor in a complete magnet induction circuit environment.

### BRIEF DESCRIPTION OF THE DRAWINGS

FIG. 1 is a diagram illustrating an embodiment of a configuration of rotor and stator with two sets of double strings and two holes. The rotor has no shaft and it is not supported by a rotor support. Pull the string holders in FIG. 1A and the double strings will untwist and cause the rotor to rotate. The double strings in FIG. 1B are untwisted. Winding of the wires is omitted for simplicity purpose.

FIG. 2 is a diagram illustrating an embodiment of a configuration of rotor and stator (front view) with two sets of double strings, two holes, and a shaft. The rotor and the shaft are not supported by a rotor support.

FIG. 3 is a diagram illustrating an embodiment of a configuration of rotor and stator (front view) with two sets of double strings and a shaft confined (supported) by two holes with bearings.

FIG. 4 is a diagram illustrating an embodiment of a configuration of rotor and stator (front view) with two sets of double strings, two holes without bearings, a hollow handle where the end of one of the two sets of double strings is pinned down at the end of the handle away from the stator frame. The rotor has no shaft and it is not supported by a rotor support.

FIGS. 5A, 5B, and 5C are diagrams illustrating embodiments of configurations of rotor and stator (front view) suitable for one side operation (with one set of double strings). The shaft is supported by a bearing.

FIGS. 6A, 6B, 6C and 6D are diagrams illustrating embodiments of configurations of rotor and stator (front view) with part of the stator frame left open. FIG. 6B and FIG. 6D are for peripheral configuration.

FIGS. 7A, 7B, 7C and 7D are diagrams illustrating embodiments of configurations of rotor and stator (front view) with axial flux configuration. The shaft is supported by a bearing.

FIG. 8 is a diagram illustrating an embodiment of an operation of untwisting strings with tearing apart pulling operation (front view).

FIG. 9 is a diagram illustrating an embodiment of a configuration of rotor and stator with a pulley system (front view).

FIGS. 10A, 10B, and 10C are diagrams illustrating embodiments of a disk (or wheel) shaped rotor with magnets. FIG. 10B (front view) is for peripheral configuration and FIG. 10C (front view) is for axial flux configuration.

FIGS. 11A, 11B, 11C and 11D are diagrams illustrating embodiments of a stator frame with coils. FIG. 11A, FIG. 11B and FIG. 11D are for peripheral configuration and FIG. 11C (front view) is for axial flux configuration.

FIG. 12 is a diagram illustrating an embodiment of an improved human powered pull string generator (front view) used in validation experiment #1. The embodiment has a peripheral configuration and has a handle.

FIG. 13 is a diagram illustrating an embodiment of the pairing of a rotor and stator used in validation experiment #3. The embodiment has a peripheral configuration with the rotor fitted inside the stator ring. It has no shaft, no bearing, and no hole.

FIG. 14 is a diagram illustrating an embodiment of a rotor-stator axial flux configuration. It was used in validation experiment #4.

### DETAILED DESCRIPTION OF THE INVENTION

The improved human powered pull strings generator of the present invention comprises a double strings rotor system, a stator system, an electrical circuit system, and a cover protection system (optionally without the cover protection system) and a method of using the improved pull strings power generator. The invention can now be illustrated by the following figures. It shall be understood that the figures throughout the specification are for illustration purposes only and they are not intended to be the finished products. The drawings are not to scale throughout the specification. For eligibility purpose, coil windings, electrical circuit system, and cover protection system will not be shown in many diagrams.

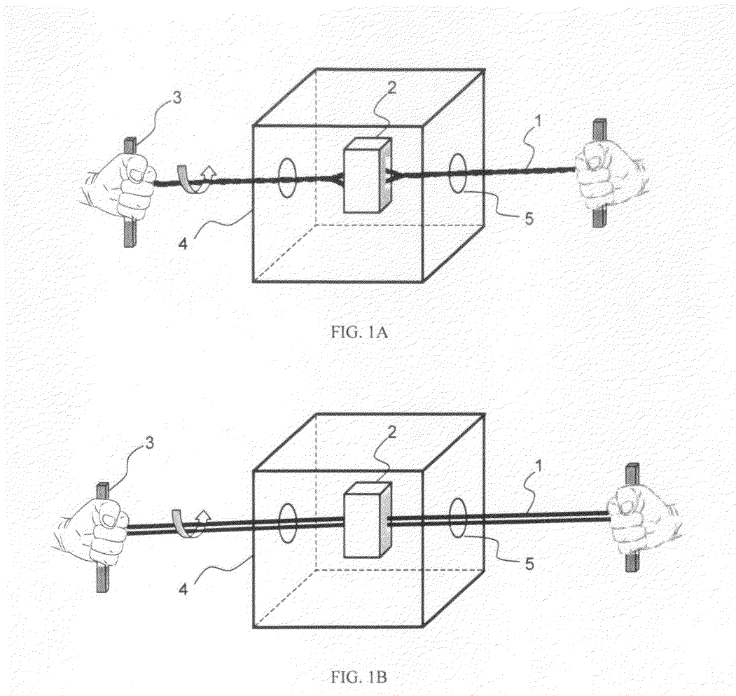

FIG. 1 illustrates an embodiment of the pairing configuration of the double strings rotor system and the stator system of the present invention where the rotor 2 is surrounded by the stator 4. We will designate 4 to be the stator or the stator frame wherever applicable throughout the specification. The rotor 2 has two sets of double strings 1 anchored at both sides, respectively. The strings 1 pass through the holes 5 on the stator frame 4. The rotation of the rotor 2 will be maintained if the strings 1 (starting in the twisted state) are pulled and un-pulled continuously by hands directly (or through the string holders 3).

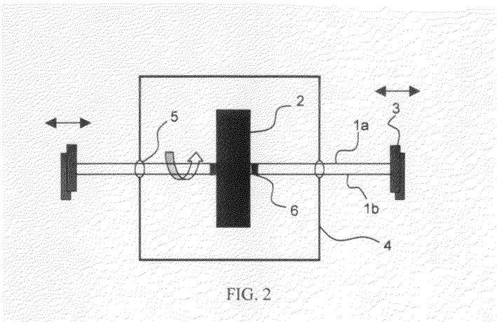

FIG. 2 illustrates another embodiment of FIG. 1 with shaft 6 supported only by the double strings 1.

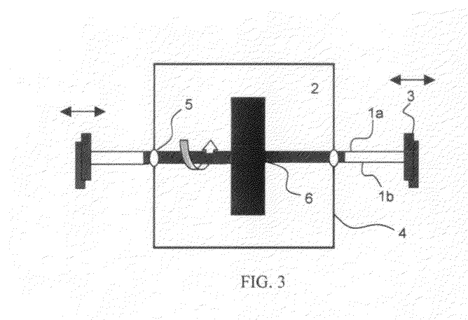

FIG. 3 illustrates yet another embodiment of the present invention where the shaft 6 is fixed (supported) at holes 5 (with bearings). It is well known to the ordinary skilled in the art that a shaft can also be supported by one or two bearings. Throughout the specification, holes 5 can be empty or have a bearing system with one or two bearings if not explicitly mentioned. If a bearing system is used, shaft 6 is fixed at hole 5. In this case, the shaft 6 (hence the rotor 2) can rotate but cannot move horizontally or vertically. This embodiment has two bearings at holes 5 for additional support to the rotor 2.

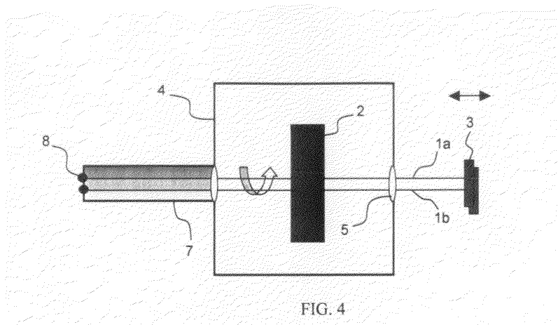

FIG. 4 illustrates yet another embodiment of the present invention where one end of the two sets of double strings is pinned down by a handle 7 at location 8. The electricity can be generated by grabbing the handle 7 with one hand while pulling/un-pulling the string holder 3 with the other hand.

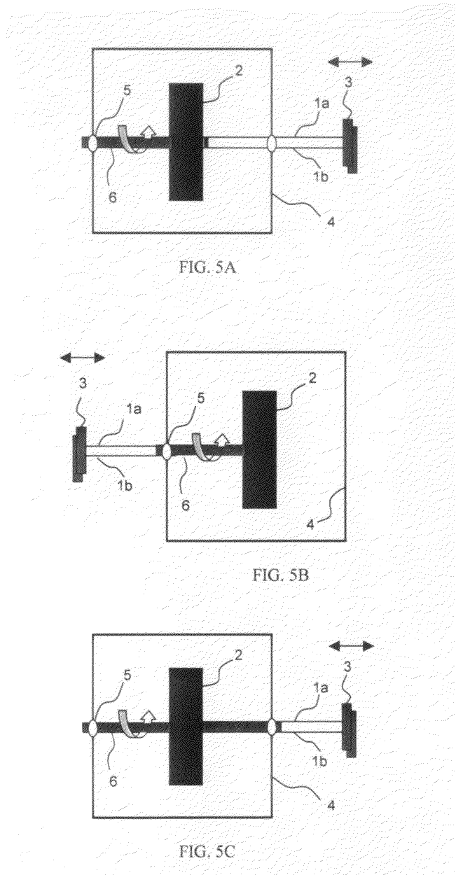

FIG. 5 illustrates yet another embodiment of the present invention where only one set of double strings 1 is used. The shaft 6 is fixed at the hole 5 (with a bearing). The one set of the double strings 1 can either anchor at the unsupported end of the shaft 6 (FIG. 5A) or at the supported end of the shaft 6 (FIG. 5B). In FIG. 5A, the double strings can also be anchored directly to the rotor if the unsupported end of the shaft becomes unnecessary. FIG. 5C has two bearings at holes 5 for additional support to the rotor. Throughout the specification, a set of double strings can mean any number of separated single strings on the same side.

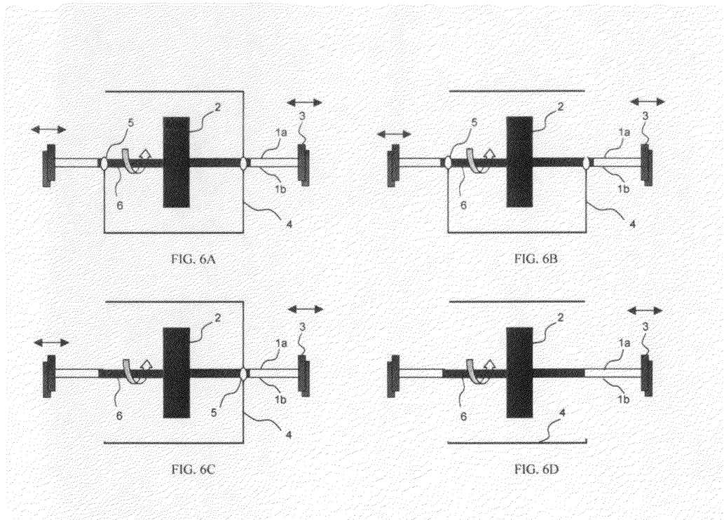

FIG. 6 illustrates yet other embodiments where the some parts of the stator frame are open.

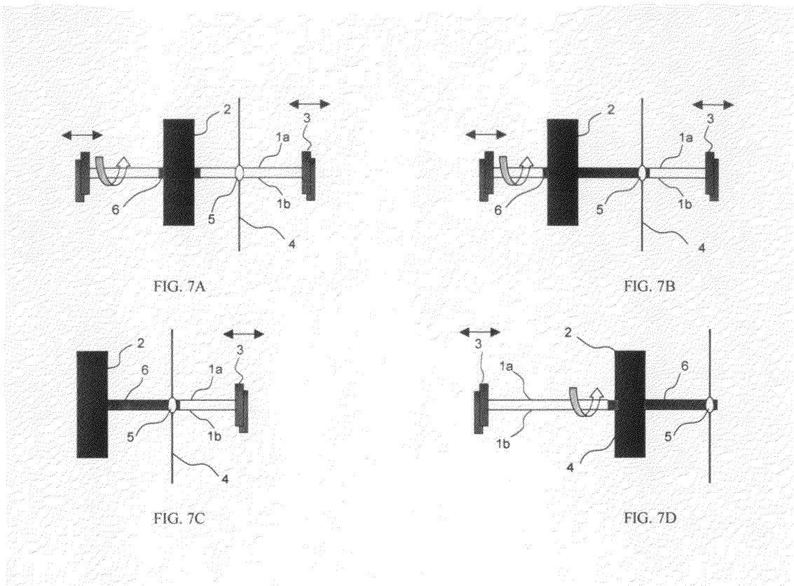

FIG. 7 illustrates yet other embodiments of the present invention where the rotor 2 and stator 4 are parallel (or face-to face in an axial flux configuration). If two sets of double strings 1 are present the hole 5 does not have to have a bearing (FIGS. 7A and 7B). However, if only one set of double strings 1 is used, hole 5 has a bearing in it (FIGS. 7C and 7D).

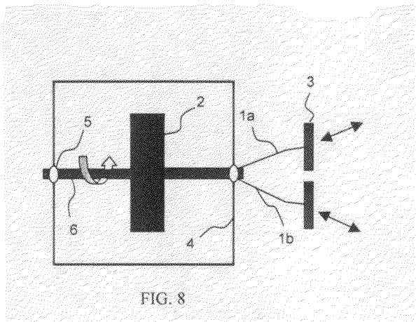

In FIGS. 1 to 7, the untwisting of the twisted double strings can be achieved by pulling, tearing apart, or a combination of pulling and tearing apart. Using FIG. 5C as an example, FIG. 8 illustrates another untwisting operation (tearing apart operation).

To simplify the language, we will use the term “pulling” to mean any actions which create a mechanical force along the axis of the rotation to make twisted strings untwisted. Therefore, the pulling action also includes the tearing apart action throughout the specification.

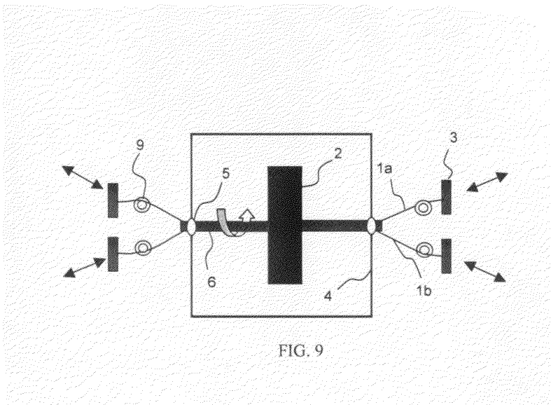

In FIG. 1 to 8, a stationary pulley system can be placed between the rotor and string holder as it is illustrated in FIG. 9 (using FIG. 3 as an example). With a pulley type of device placed between the rotor and the string holder, the string can be bent during pulling. The embodiment with the pulley system is particularly useful as an exercise machine.

Throughout the specification, when there are two sets of double strings 1 and at least one end of the shaft 6 is fixed by a bearing at a hole 5, the pulling can be done asymmetrically. Asymmetric pulling means when one side of the double string 1 is being pulled (untwisting), the other side is being un-pulled (twisting). This is useful when the output power is large and the increased resistance (due to the induced magnetic field) to the rotor does not allow the rotor to return from its untwisted state to the twisted state easily under its own inertia during un-pulling.

The essential components of the preferred designs of the rotor-stator configurations are summarized in Table 1.

TABLE 1
Essential components of preferred rotor stator designs

| | | | | No. of | No. of holes | No. of | | | |
|---|---|---|---|---|---|---|---|---|---|
| | No. of | Set of | No. of | holes with | without | hollow | | Axial | |
| | Stator | strings | shaft | bearings | bearings | handles | Pulley | flux | Peripheral |
| 1 | 1 | 1 | 1 | 1 | 0 | 0 | Yes or No | Yes | |
| 2 | 1 | 1 | 1 | 1 | 0 | 0 | Yes or No | | Yes |
| 3 | 1 | 1 | 1 | 2 | 0 | 0 | Yes or No | Yes | |
| 4 | 1 | 1 | 1 | 2 | 0 | 0 | Yes or No | | Yes |
| 5 | 1 | 2 | 0 or 1 | 0 | 0 | 0 | Yes or No | | Yes |
| 6 | 1 | 2 | 0 or 1 | 0 | 1 | 0 | Yes or No | Yes | |
| 7 | 1 | 2 | 1 | 1 | 0 | 0 | Yes or No | Yes | |
| 8 | 1 | 2 | 1 | 1 | 0 | 0 | Yes or No | | Yes |
| 9 | 1 | 2 | 1 | 2 | 0 | 0 | Yes or No | Yes | |
| 10 | 1 | 2 | 1 | 2 | 0 | 0 | Yes or No | | Yes |
| 11 | 2 | 1 | 1 | 1 | 0 | 0 | Yes or No | Yes | |
| 12 | 2 | 1 | 1 | 1 | 1 | 0 | Yes or No | Yes | |
| 13 | 2 | 1 | 1 | 2 | 0 | 0 | Yes or No | Yes | |
| 14 | 2 | 2 | 0 or 1 | 0 | 2 | 0 | Yes or No | Yes | |
| 15 | 2 | 2 | 1 | 1 | 1 | 0 | Yes or No | Yes | |
| 16 | 2 | 2 | 1 | 2 | 0 | 0 | Yes or No | Yes | |
| 17 | 1 | 2 | 0 or 1 | 0 | 1 | 1 | No | Yes | |
| 18 | 1 | 2 | 0 or 1 | 0 | 1 | 1 | No | | Yes |
| 19 | 1 | 2 | 0 or 1 | 0 | 2 | 1 | No | | Yes |

The magnet and coil, not mentioned explicitly in Table 1, are by default always in the rotor-stator design and this is true throughout the specification.

For the purpose of clarity, other examples of the double strings rotor system and the stator system of the present invention will not be discussed in detail so that the invention is not unnecessarily obscured. The double strings rotor system of the present invention is suitable for all known rotor-stator configurations for power generation and therefore all of the known rotor-stator configurations, when used in the improved human powered pull strings generator of the present invention, are within the scope of the present invention. These include, but are not limited to, the rotor-stator designs (including electrical circuits) discussed in the following publications: Design of Brushless Permanent-Magnet Motors. J. R. Hendershot Jr. and Tje Miller, 1994, Magan Physics Publishing and Clarendon Press; Permanent Magnet Motor Technology: Design and Applications, Second Ed., Revised and Expanded. Jack F. Gieras and Mitchell Wing, 2002. Marcel Dekker, Inc; Handbook of Electric Motors, Second Edition, Revised and Expanded. Hamid A. Toliyat and Gerald B. Kilman (eds.), 2004. Marcel Dekker, Inc.; and Alternator Secrets by Thomas Lindsay.

As it was pointed out earlier, the rotor can have either the magnets or the coils. In the case that the rotor is the one with magnets, the stator is the one with conducting coils. In the case that the rotor is the one with the coils, the stator is the one with magnets.

When the rotor has the magnet, the rotor itself illustrated in FIG. 1-9 can be a magnet such as a bar magnet, a spherical magnet, a ring magnet, or a cylindrical magnet.

In FIGS. 1 to 9, the rotor can be in any shape as long as its center of gravity is balanced along the pulling axis of the double strings. However, the rotors with a disk shape and a rectangular shape are preferred.

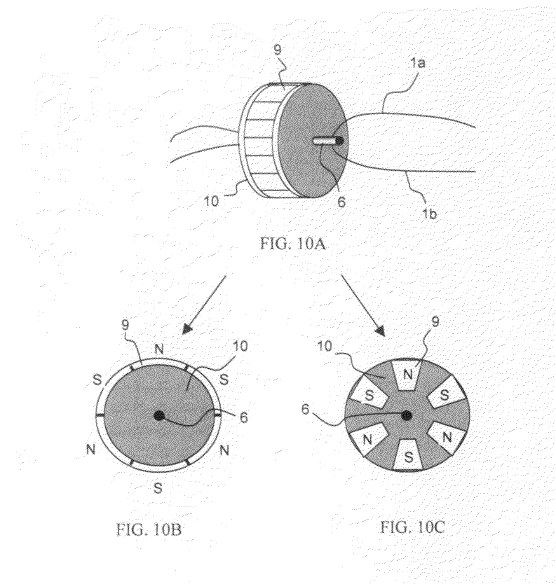

If the rotor itself does not entirely comprise the magnets, the rotor illustrated in FIGS. 1-9 can have a support for the magnet(s). FIG. 10A illustrates an embodiment of a disk-shaped rotor system with magnets of the present invention. It comprises a rotor with a disk shaped support 10 supporting the magnets 9, a shaft 6 and double strings 1. The disk shaped support comprises two disk-shaped plates sandwiching the magnets 9, and an internal support (optional) for the magnets. The strings 1 are anchored at the shaft 6. FIG. 10B illustrates an embodiment of the rotor system of the present invention shown in FIG. 10A. This design (FIG. 10B), suitable for peripheral configuration, comprises magnets 9 arranged alongside the peripheral of the support with the N/S poles of the magnets pointing perpendicularly to the rotating axis. FIG. 10C illustrates another embodiment of the rotor system of the present invention shown in FIG. 10A. This design (FIG. 10C), suitable for axial flux configuration, comprises magnets 9 arranged so that the N/S poles of the magnets are parallel with the rotating axis. In both FIGS. 10B and 10C the top plate and the strings are omitted for illustration purpose. The number of magnets shown in FIGS. 10B and 10C is six. However, the number of magnets can be any value greater than one, though the preferred numbers are an even number greater than five. Moreover, the shape of the magnets can be rectangular (including square), circular, arc, wedged, and wedged with a curve on one side.

The separation distance of the double strings at the anchoring points can be any length as long as they are kept separated. However, it is preferred to be about 1 mm to about ⅔ mass distance where the ⅔ mass distance is defined as the distance that, if a cylinder is cut out using the distance as the diameter around the center of the rotor, the cut out mass would be ⅔ of the total mass. If the distance is either too small or too large the pulling force may not be large enough to rotate the rotor. It shall be understood that the distance of the anchoring points is always properly selected throughout the specification.

There are many ways to anchor the strings to the rotor. One way is to anchor the strings to small hooks bound to both sides of the rotor or its shaft (if present). There can be more than two hooks, for example, four, on each side of the rotor; each hook can have at least one string. Another way to anchor the strings is to anchor them to the holes cut through the tip of the shaft. Other ways of anchoring the strings to the rotor (or shaft) will not be discussed further because the practice is well known to the ordinary skilled in the art.

Throughout the specification the words “anchor,” “fixed,” “bond,” “attach,” and “fasten” all mean that one object is attached firmly to another object using all methods known to the ordinarily skilled in the art including but not limited to gluing, taping, nailing, tying, clamping, and welding.

It shall be pointed out that (1) the untwisted double strings on one side of the shaft do not have to be on the same plane as the double strings on the other side; (2) the double strings rotor system can have more than one set of double strings on each side with more than two anchoring points on each side of the rotor; and (3) the double strings on both side of the rotor can have different lengths. For the purpose of simplicity, other examples of anchoring design and double strings configuration, though they are also within the scope of the present invention, will not be discussed in detail so that the invention is not unnecessarily obscured.

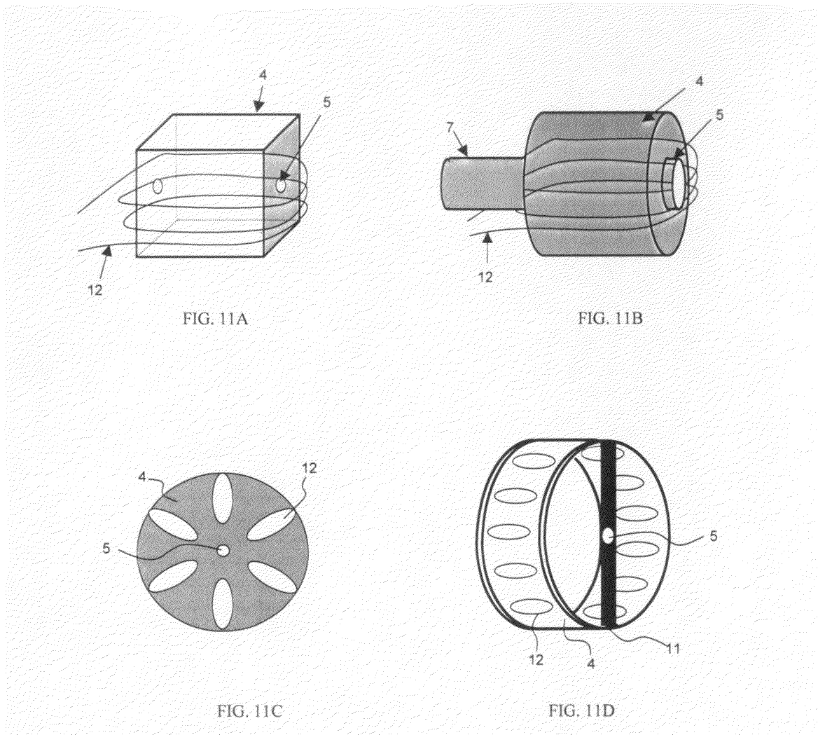

In FIGS. 1-9, the stator or stator frame 4 has the coils when the rotor has the magnets. The coil winding method is well known to the ordinary skilled in the art. The stator frame 4 can be a rectangular box, a cylinder, a disk (or wheel), a ring, or any other shape as long as it permits the winding of the wires and rotation of the rotor. The stator frame 4 can be only a skeleton frame, only sheets without frames, or any combination of both. FIG. 11 illustrates four non-limiting examples of a stator with coils. Other stator designs and winding methods, though not illustrated herein, are also suitable for the present invention.

FIG. 11A illustrates a stator where the wire 12 is wound around a rectangular stator frame 4 with two holes 5. FIG. 11B illustrates a stator where the wire 12 is wound around a (hollow) cylindrical stator frame 4 with two holes 5 and a handle 7. FIG. 11C illustrates a stator where the coils 12 are placed on a thin disk-shaped stator frame 4 with one hole 5. FIG. 11D illustrates a stator design comprising a rotor support system 11 with a bearing in a hole 5, coils 12, and a ring-shaped stator frame 4. The coils in FIG. 11D can be either outside or inside of the ring. The stator illustrated in FIG. 11D can pair up either with a bar magnet with N/S poles at the long ends or a wheel-shaped rotor (for example, FIG. 10B). In FIGS. 11C and 11D the coils are properly connected. The number of coils shown in the figure is for illustration purposes only. The number of coils used is related to the number of magnets used in the rotor, which is well known to the skilled in the art.

The wire should not cover the whole surface of the stator frame. In one embodiment, at least one area of the stator frame 4 is left open (optionally with a door) for easy access to the rotor system. In designs similar to FIGS. 11A and 11B, the wires are always wound around the holes 5 or the handle 7 (if present).

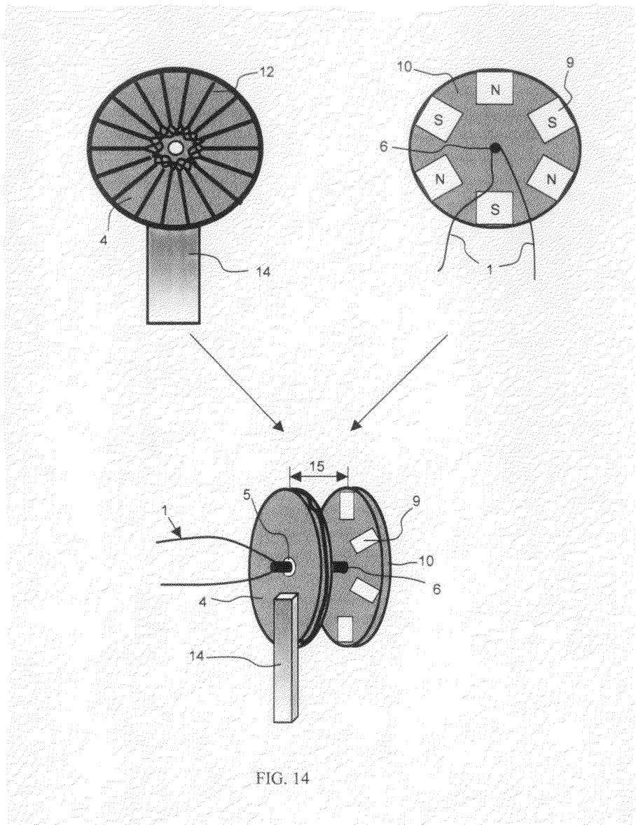

Many types of rotors with magnets can be paired up with the stators with coils. For example, a rectangular bar magnet as the rotor, a cylindrical magnet as the rotor, a spherical magnet as the rotor, or a wheel rotor exemplified by FIG. 10B can be paired up with stators exemplified by FIG. 11A, FIG. 11B, and FIG. 11D, respectively, in a peripheral configuration. A wheel-shaped rotor exemplified by FIG. 10C can be paired up with the stator exemplified by FIG. 11C in an axial flux configuration. In this case, there can be one (as exemplified by FIG. 7 and FIG. 14) or two stators sandwiching the rotor (not shown).

As it was pointed out earlier, the rotor-stator pair can also be one in which the rotor contains the coils and the stator contains the magnets. FIGS. 1-9 also illustrates these designs.

The generator of present invention can be operated by more than one person. For example, one person can operate one set of double strings on one side while the other operates the other set of double strings on the other side. This is preferred when the size of the generator of the present invention is large or when the pulling and un-pulling by one person becomes difficult due to large power output.

Validation Experiment #1: The rotor system consisted of a rectangular (1.5×½×½″) bar magnet (three ½×½×½″ neodymium magnets joined together). There was a hole in the middle of the magnet. Two sets of double strings were anchored at the magnet. The length of the untwisted double strings (1a and 1b) ( 1/16″ Nylon) on one side was approximately 16 cm. Pulling distance from twisted state to un-twisted state was only about 5 cm. The weigh of the rotor system was 47 grams. At no-load condition, the rotor speed was about 3000 rpm.

The stator system (as illustrated by FIG. 11B, not to scale): The wiring supporting frame 4 was a hollow cylinder (one plastic bottle with 3″ OD and 2.5″ long). The winding used ˜128 grams of 24 AWG magnetic wire with a resistance of 5.9 ohms. The coil 12 had a total of 255 turns of wire on the frame 4. A 12 cm long 5/8″ copper tube was used as the handle 7. A ˜5/8″ hole 5 (without a bearing) was cut to join the copper tube at the center of the left surface of the frame 4 and another 3 cm diameter hole 5 (without a bearing) was cut at the center on the right surface of the frame 4 for the strings to go through. Total weight of the stator was ˜215 grams.

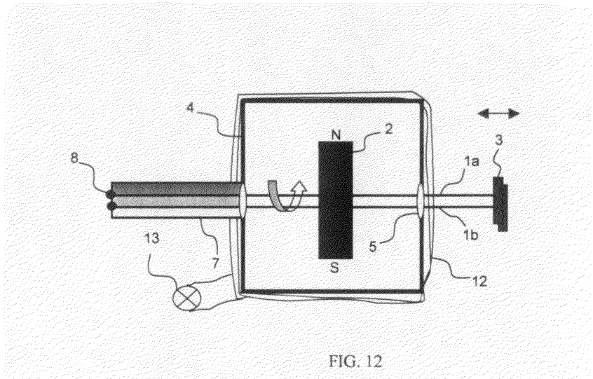

The improved pull strings generator of the invention is illustrated in FIG. 12 (not to scale). This was a peripheral configuration and it was a single phase generator.

The left double strings were pinned at the end place 8 of the handle 7. The electricity was generated by grabbing the handle 7 with one hand while pulling/un-pulling the string holder 3 with the other hand. The start and end of the wire 12 were connected to an electrical device 13.

Without rectification and without load, the peak output voltage of the device was ˜six volts. It was not possible to sustain the pulling/un-pulling action while measuring the current using a RadioShack® digital multimeter (CAT. NO. 22-813, used throughout the specification) because the current was too large which created a strong induced counter magnetic field around the conducting wire 12 and slowed the rotor magnet 2 down.

With one N-4001 diode as the rectifier (½ wave rectification) but without additional load, the peak output voltage was ˜4 volts and peak current was ˜520 mA (DC). The pulling and un-pulling operation did not require a lot of physical effort.

With four N-4001 diodes as a bridge rectifier (full wave rectification) but without additional load, the peak voltage was ˜6 volts and peak current was ˜520 mA (DC). The pulling and un-pulling operation did not require a lot of physical effort.

With four N-4001 diodes and two 40 μF (50V) capacitors as the bridge rectifier but without additional load, the peak voltage was 20 V and peak current was ˜500 mA. The pulling and un-pulling operation did not require a lot of physical effort. The rotation speed of the rotor was ˜1440 rpm.

With four N-4001 diodes, two 40 μF (50V) capacitors and additional twelve LEDs in series, the peak voltage was 12 volts and peak current was ˜90 mA. The twelve LEDs shined quite brightly at the peaked output power. The pulling and un-pulling operation did not require a lot of physical effort. In a separate measurement without connecting to the generator, the measured voltage was 12 volts and current was 86 mA when the twelve LEDs and eight “AA” batteries were connected in series.

Validation Experiment #2 (referred to FIG. 5A with a handle): The rotor system comprised three ½×½×½″ neodymium magnets joined together to form a one piece bar magnet 2 (1.5×½×½″). There was only one set of double strings anchored to the rotor. The length of the untwisted double strings (1a and 1b) ( 1/16″ Nylon) was 23 cm. Pulling distance from twisted state to un-twisted state was only about 7 cm. There was a one-side shaft fixed to a bearing in stator frame 4. The weight of the rotor system was 47 grams. At no-load condition, the rotor speed was about 2500 rpm (˜57 cycles of pulling/un-pulling per minute).

The stator: Same stator as in validation result #1 except a bearing (5 mm ID, 11 mm OD, 4 mm thick) was fixed to a piece of wood which was attached to the left side of the stator frame 4.

This was a peripheral configuration and it was a single phase generator.

The electricity was generated by grabbing the handle 7 (without strings inside) with one hand while pulling/un-pulling the string handle 3 with the other hand.

With four N-4001 diodes and two 40 μF (50V) capacitors and without additional load, the peak voltage was 18 V and peak current was ˜300 mA.

Validation Experiment #3 (referred to FIG. 2): The rotor system (referred to FIG. 10B) comprised a wheel-shaped rotor support 10, a 2″ ID (2⅜″ OD) PVC pipe sandwiched by two plastic plates, eight 1″× 6/8″×⅛″ curved neodymium magnets 9 (magnetized through ⅛″) evenly arranged along the peripheral of the PVC pipe 10. The overall size of the rotor was 2⅝″ (67 mm) OD and 28 mm thick. Two sets of double strings 1 were anchored directly at the rotor body (no shaft). The string ( 1/16″, not Nylon) length in its untwisted state was 19 cm (one side) and in its twisted state was 14 cm. Total weight of the rotor was 120 g. The rotation speed (no load) was ˜840 rpm.

The stator comprised eight coils 12 taped inside of a stator frame 4 which was a 4″ ID PVC tube. Each coil (˜2 cm×˜20 cm) was ˜24 grams and had ˜67 turns of 24 AWG wire. The coils were connected to become a single phase generator. The resistance of the wires in series was 9 ohms.

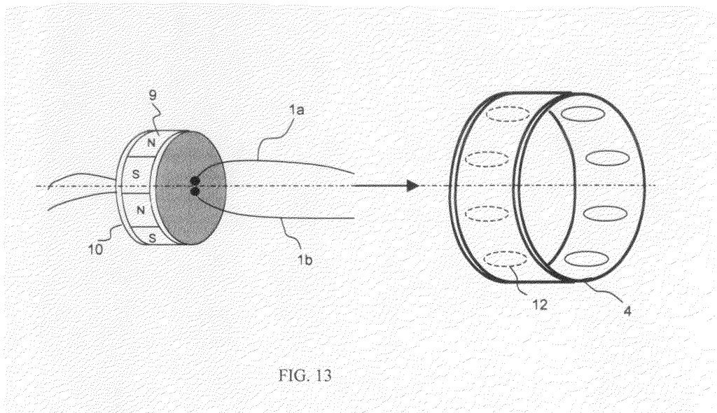

FIG. 13 illustrates the rotor-stator pairing (not to scale). This was a peripheral configuration. The gap between the rotor magnets and the coils was ˜6 mm on average.

With the rotor inside the stator, the electricity was generated by pulling/un-pulling the strings with both hands.

Without rectification and without load, the peak output voltage was ˜6 volts and peak current ˜300 mA (AC). The pulling and un-pulling action did not require a lot of physical effort.

With one N-4001 diode as the rectifier (½ wave rectification) and without additional load, the peak output voltage was ˜3 volts and peak current ˜200 mA (DC). The pulling and un-pulling action did not require a lot of physical effort.

With four N-4001 diodes and two 40 μF (50V) capacitors and without additional load, the peak voltage is 19 V and peak current was ˜220 mA (DC). The pulling and un-pulling action required some physical effort.

Validation Experiment #4: The rotor system (referred to FIG. 10C) comprised a thin steel disk (3.5″ OD× 1/16″ thick) as the rotor support 10 supporting six 1″×1″×¼″ rectangular neodymium magnets 9 (magnetized through ¼″) evenly. Only one set of double strings ( 1/16″ Nylon) was anchored at the shaft 6. The shaft was supported by a bearing (6 mm ID, 12 mm OD, 4 mm thick) in a hole 5 on the stator frame 4. The string length in its untwisted state was 19.5 cm and in its twisted state was 15 cm. Total weight of the rotor was 346 g. The rotation speed of the rotor (no load) was ˜800 rpm.

The stator comprised coils 12 on a stator frame 4 (referred to FIG. 11C), which was made of plastic, with a diameter of 3.5″ and 13 mm thick. A hole 5 was drilled to fit the bearing. Three sets of 32 AWG wire were used. Each set had a resistance of ˜20.2 ohms and had 50 turns. The three sets of wires were wound into 18 slots and they were connected using a 3-phase DELTA. Each slot had 100 turns of wiring. A flat wooden leg 14 (paint stirrer) was attached to the stator frame 4. The total weight of the stator was 113 grams. The stator was clamped to a workbench through the wooden leg 14.

The rotor support (the steel plate) and the stator (except the bearing and the shaft) were from http://www.windstuffnow.com/main/3phase_turbine_kit.htm designed by Ed. Lenz.

FIG. 14 illustrates this embodiment (not to scale). This is an axial flux configuration. The gap 15 between the rotor and the stator was about 2-4 mm.

With the wooden leg 14 clamped to a workbench, the electricity was generated by pulling and un-pullinge string 1.

With six N-4001 diodes serving as the bridge rectifier, the peak voltage was ˜six volts. The measured current was ˜200 mA (DC). The pulling and un-pulling operation was difficult to sustain. When current is generated in the coils, it also creates an induced magnetic field that slows down the rotor speed. As the current increases, it requires more effort to make the rotor rotate. When the rotor inertia is not large enough, this induced magnetic field may become substantial and it may reduce the momentum of the rotor during the un-pulling stage.

There are several ways to overcome the difficulty of the sustained pulling/un-pulling operation. One way used by the inventors herein was to disconnect the circuit each time the double string finished the pulling action. Because the circuit was disconnected, there was no induced magnetic field to slow down the rotor so the rotor continued to twist the double strings using its own inertia. Another way used was to use another set of double strings anchored at the shaft on the rotor side and perform asymmetric pulling and un-pulling. This way the rotor was subjected to alternate, but constant pulling action. The results (peak values) obtained were the same as before (˜6 V and ˜200 mA) in both cases. Optionally, the gap could be increased between the magnet and the coil and this would make it easier to pull and un-pull.

It can be seen from these examples of non-refined prototypes that the pull string generators of the present invention are capable of generating high enough voltage and current. It should be obvious to the ordinary skilled in the art that by using a current and voltage conditioning device and by further adjusting the wire size, number of wiring turns, gap between the magnet and the stator wires, and magnet strength, a refined generator and a charging device can be built to suit many applications.

In another embodiment, the generator of the present invention has an attachment (such as a rectangular ring shaped handle) capable of attaching the generator to a stationary place (such a foot) so that the generator can be held still during operation.

The string used in the present invention can be made from any material as long as it is twistable and strong. It can be metal, alloy, natural fiber, synthetic fibers, or mixtures of them. However, fibers are preferred. The string diameter can be any size as long as it is strong enough for pulling. However, the diameter of the string is preferably from 0.1 mm to about 30 mm, more preferably from 0.5 mm to 20 mm, or most preferably from 1 mm to 10 mm. The length of the string is at least 3 cm, preferably 5 cm-200 cm, more preferably, 10-150 cm, most preferably 15 cm-100 cm.

The frame material can be made from metal, wood, plastic, paper cardboard, or any mixture of them. However, plastic or metal is preferred.

We claim:

1) An improved human powered pull strings generator comprising a double strings rotor system, a stator system, an electrical circuit system, and a cover protection system (optionally without the cover protection system), wherein the double strings rotor system comprises a rotor which, configured to be pulled, comprises at least one magnet (or coil) with a support (optionally without the support), a rotor shaft (optionally without the rotor shaft), at least one set of double strings anchored to the rotor or to the shaft, and 0-2 sets of string holders;

2) Wherein claim 1, the stator system of the said improved human powered pull strings generator comprises at least one stator with at least one coil (or one magnet) supported by a stator frame, at least one handle (optional without a handle), 0-2 holes (optionally with 0-2 bearings), optionally a pulley system, and optionally an attachment capable of attaching the stator system to a stationary place;

3) Wherein claim 2, the said improved human powered pull strings generator has two sets of double strings and has no bearings;

4) Wherein claim 3, the stator system in the said improved human powered pull strings generator has at least one coil and a hollow handle in which the strings can pass through and whose end can be used to pin down the end of the strings;

5) Wherein claim 2, the number of double strings sets and number of shafts in the said improved human powered pull strings generator is 1, and the said stator system has at least one stator and at least one bearing supporting the shaft;

6) Wherein claim 5, the said improved human powered pull strings generator is in a peripheral configuration and has 1 stator with at least 1 bearing supporting the shaft, and has a cover protection system;

7) Wherein claim 5, the said improved human powered pull strings generator is in an axial flux configuration, has 1 stator with 1 bearing supporting the shaft, and has a cover protection system;

8) Wherein claim 5, the said improved human powered pull strings generator has at least one magnet in the rotor and has at least one coil in the stator;

9) Wherein claim 8, the improved human powered pull strings generator has a pulley system;

10) Wherein claim 5, the said improved human powered pull strings generator has at least one coil in the rotor and has at least one magnet in the stator;

11) Wherein claim 2, the number of double strings set and number of shaft in the said improved human powered pull strings generator is 2 and 1, respectively, and the said stator system has one stator and one or two bearings supporting the shaft;

12) Wherein claim 11, the said improved human powered pull strings generator is in a peripheral configuration and has a wheel-shaped rotor, a ring-shaped stator, and a cover protection system;

13) Wherein claim 12, the said rotor has at least one magnet and the said stator has at least one coil;

14) Wherein claim 12, the said rotor has at least one coil and the said stator has at least one magnet;

15) Wherein claim 13, the said improved human powered pull strings generator has a pulley system;

16) Wherein claim 11, the said improved human powered pull strings generator is in an axial flux configuration and has a disk-shaped rotor, a disk-shaped stator, a pulley system, and a cover protection system;

17) Wherein claim 2, the number of double strings set and number of shaft in the said improved human powered pull strings generator is 2 and 1, respectively, the said stator system has 2 stators sandwiching a disk-shaped rotor and 2 bearings supporting the shaft, and the said improved human powered pull strings generator is in an axial flux configuration and it has a cover protection system;

18) Wherein claim 17, the rotor in the said human powered pull strings generator has at least one magnet and the said stator system has at least one coil and a pulley system;

19) Wherein claim 17, the rotor in the said human powered pull strings generator has at least one coil and the said stator has at least one magnet;

20) A pull strings power generation method of using an improved human powered pull strings generator to power an electrical device comprising the following steps: (1) from its initial still state, rotate the rotor slowly so as to twist the double strings anchored to the rotor; (2) pull the strings so that it creates a mechanical force along the axis of the rotation. The pulling force un-twists the double strings making the rotor rotate in an opposite direction; (3) as soon as the double strings are un-twisted to the un-twisted state (the longest string state), un-pull the strings; (4) when the strings are twisted again, pull the strings again. (5) repeat step (2) to (4) to maintain the rotation of the rotor; wherein the improved pull strings human powered generator comprises a double strings rotor system, a stator system, an electrical circuit system, and a cover protection system (optionally without the cover protection system), wherein the rotor system comprises a rotor which, configured to be pulled, comprises at least one magnet (or coil), a rotor shaft (optionally without the rotor shaft), at least one set of double strings anchored to the rotor or to the shaft, and 0-2 sets of string holders.
